(19) United States
(12) Patent Application Publication
(10) Pub. No.: US 2005/0278383 A1
(43) Pub. Date: Dec. 15, 2005

(54) Method and apparatus for keeping a file system client in a read-only name space of the file system

(75) Inventors: Mike Kazar, Pittsburgh, PA (US); Michael J. LaRocca, Valencia, PA (US); William L. Snider, Sewickley, PA (US); Andrew G. Reynolds, Mars, PA (US)

Correspondence Address: Ansel M. Schwartz, Suite 304, 201 N. Craig Street, Pittsburgh, PA, 15213, US

(73) Assignee: Network Appliance, Inc.

(21) Appl. No.: 10/856,469

(22) Filed: May 28, 2004

(51) Int. Cl. G06F 7/00; G06F 15/16

(52) U.S. Cl. 707/200; 709/203

(57) ABSTRACT

An apparatus for keeping a file system client in a read-only name space of the file system includes a system management component which sends “create” calls in response to mount “commands”. The apparatus includes at least a first disk element in communication with the system management component which receives the “create” calls and creates mount points in the read only name space in response to the mount “commands”. A method for keeping a file system client in a read-only name space of the file system includes the steps of creating a context mount point in an existing unit of a file system, where the unit is preferably VFS, in the read-only name space. There is the step of adding a new VFS to the name space at the mount point to the existing VFS.

### FIELD OF THE INVENTION

The present invention is related to keeping a file system client in a read-only name space of the file system. More specifically, the present invention is related to keeping a file system client in a read-only name space of the file system by creating mount points in a read only name space of parent VFS and mounting a child VFS at a mount point in the parent VFS and mirroring the name space of the parent VFS in the read only name-space of the child VFS.

### BACKGROUND OF THE INVENTION

A storage system is a computer that provides storage (file) service relating to the organization of information on storage devices, such as disks. The storage system may be deployed within a network attached storage (NAS) environment and, as such, may be embodied as a file server. The file server or filer includes a storage operating system that implements a file system to logically organize the information as a hierarchical structure of directories and files on the disks. Each “on-disk” file may be implemented as a set of data structures, e.g., disk blocks, configured to store information. A directory, on the other hand, may be implemented as a specially formatted file in which information about other files and directories are stored.

Disk storage is typically implemented as one or more storage “volumes” that reside on physical storage disks, defining an overall logical arrangement of storage space. A physical volume, comprised of a pool of disk blocks, may support a number of logical volumes. Each logical volume is associated with its own file system (i.e., a virtual file system) and, for purposes hereof, the terms volume and virtual file system (VFS) shall generally be used synonymously. The disks supporting a physical volume are typically organized as one or more groups of Redundant Array of Independent (or Inexpensive) Disks (RAID).

In a file server environment, including network file system (NFS) server implementations, export lists are typically utilized as an access control mechanism to restrict access to portions of the server's unified view, i.e., name space, of storage resources on a per pathname basis using a network address, such as an Internet Protocol (IP) address, of a client. An export list consists of a set of pairings of mount points and host lists. The mount point identifies a path name, i.e., a location within the file server name space (such as a directory) that is protected by the export list. The host list includes a listing of network addresses to which the export list is applied. Typically, the host list also specifies a set of permissions associated with each network address. Each incoming data access request served by the file server has a file handle, including a pathname which includes a portion that identifies a VFS associated with the request. When a data access request issued by a client to access, e.g. a file, is received at the server, the pathname of the file is parsed to determine the appropriate mount point. Once the mount point is identified, the file server locates the network address in the appropriate host list to determine if access is to be granted.

Filers are deployed within storage systems configured to ensure availability, reliability and integrity of data. In addition to RAID, storage systems often provide data reliability enhancements and disaster recovery techniques, such as clustering failover, snapshot, and mirroring capability. In the first of these techniques, in the event a clustered filer fails or is rendered unavailable to service data access requests to storage elements (e.g., disks) owned by that filer, a cluster partner has the capability of detecting that condition and of taking over those disks to service the access requests in a generally client transparent manner.

A prior approach providing copies of a storage element in case the original becomes unavailable uses conventional mirroring techniques to create mirrored copies of disks often at geographically remote locations. These copies may thereafter be “broken” (split) into separate copies and made visible to clients for different purposes, such as writable data stores. For example, assume a user (system administrator) creates a storage element, such as a database, on a database server and, through the use of conventional asynchronous/synchronous mirroring, creates a “mirror” of the database. By breaking the mirror using conventional techniques, full disk-level copies of the database are formed. A client may thereafter independently write to each copy, such that the content of each “instance” of the database diverges in time.

A noted disadvantage of these prior art approaches to ensuring the continued data availability to clients is responding quickly to client requests when many clients are requesting the same information at essentially the same time from the location where the information is stored.

### SUMMARY OF THE INVENTION

Context mount points allow for load-balancing client accesses across multiple copies of a file system name space.

The present invention includes a method for keeping a file system client in the read-only name space when the client crosses a mount point within the read-only name space. Conversely, clients stay in the read-write name space when crossing a mount point within the read-write name space. It is the client context prior to crossing a mount point which influences the file server's response to a client protocol lookup.

The present invention pertains to an apparatus for keeping a file system client in a read-only name space of the file system. The apparatus comprises a system management component which sends “create” calls in response to mount “commands”. The apparatus comprises at least a first disk element, preferably a D-blade, in communication with the system management component which receives the create calls and creates mount points in the read only name space in response to the mount commands.

The present invention pertains to a method for keeping a file system client in a read-only name space of the file system. The method comprises the steps of creating a context mount point in an existing unit of a file system, where the unit is preferably a VFS, in the read-only name space. There is the step of adding a new VFS to the name space at the mount point to the existing VFS.

### BRIEF DESCRIPTION OF THE DRAWINGS

In the accompanying drawings, the preferred embodiment of the invention and preferred methods of practicing the invention are illustrated in which:

FIG. 1 is a schematic block diagram of a plurality of nodes interconnected as a cluster that may be advantageously used with the present invention.

FIG. 2 is a schematic block diagram of a node that may be advantageously used with the present invention.

FIG. 3 is a schematic block diagram illustrating the storage subsystem that may be advantageously used with the present invention.

FIG. 4 is a schematic block diagram of a storage operating system that may be advantageously used with the present invention.

FIG. 5 is a schematic block diagram of a D-blade that may be advantageously used with the present invention.

FIG. 6 is a schematic block diagram illustrating the format of a SpinFS request that may be advantageously used with the present invention.

FIG. 7 is a schematic block diagram illustrating the format of a file handle that may be advantageously used with the present invention.

FIG. 8 is a schematic block diagram illustrating a collection of management processes that may be advantageously used with the present invention.

FIG. 9 is a schematic block diagram illustrating a distributed file system arrangement for processing a file access request in accordance with the present invention.

FIG. 10 is a schematic representation of two VFSes and mirrors of the read-write space.

FIG. 11 is a schematic representation of a client request in regard to the apparatus of the present invention.

### DETAILED DESCRIPTION

Referring now to the drawings wherein like reference numerals refer to similar or identical parts throughout the several views, and more specifically to FIG. 11 thereof, there is shown an apparatus 10 for keeping a file system client in a read-only name space of the file system. The apparatus 10 comprises a system management component which sends “create” calls in response to mount “commands”, preferably carried out by management of the server. The apparatus 10 comprises at least a first disk element, preferably, a first D-blade 500, in communication with the system management component which receives the create calls and creates mount points in the read only name space in response to the mount commands.

Preferably, the D-blade 500 has a plurality of existing parent VFS, and the D-blade 500 creates the mount points in the parent VFS and mounts a child VFS at a mount point in the parent VFS. There is preferably a VFS location database which maintains locations of all VFS in communication with the D-blade 500. Preferably, the system management component includes a network element, preferably, an N-blade 110, in communication with the D-blade 500 and the database which receives look-up requests from clients.

The present invention pertains to a method for keeping a file system client in a read-only name space of the file system. The method comprises the steps of creating a context mount point in an existing unit of a file system, where the unit is preferably a VFS, in the read-only name space. There is the step of adding a new VFS to the name space at the mount point to the existing VFS.

Preferably, there is the step of receiving a mount command for the new VFS at a system network component. There is preferably the step of sending a create call to a disk element, preferably, a D-blade, to create the mount point. Preferably, the adding step includes the step of forming a parent and child relationship between the existing VFS and the new VFS, respectively. The creating step preferably includes the step of creating the mount point having a name of the child VFS.

Preferably, there is the step of initializing internal bi-directional meta-data between the parent VFS and the child VFS. Bi-directional meta-data is meta-data that has information about both the parent and the child. There is preferably the step of creating a client visible mount point object in the file system. Preferably, there is the step of initializing internal meta-data within the child VFS to refer to the parent VFS. The initializing internal meta-data within the child of the VFS step preferably includes the step of referring the internal meta-data with the child VFS to both a directory and the mount point within the directory of the parent VFS. In other words, the child VFS is able to obtain required information from the parent VFS in the opposite direction from which it was created.

Preferably, there is the step of verifying the parent VFS exists. There is preferably the step of verifying the parent VFS is not already mounted. Preferably, there is the step of learning a file ID of the directory having the mount point. There is preferably the step of constructing a mount string having a name of the VFS child. Preferably, the parent VFS has a read-write name space and includes the step of mirroring the name space of the parent VFS in a read only name-space of the child VFS.

Preferably, there is the step of gaining access by the client to the mirrored name space of the child VFS through a root VFS. The gaining access step preferably includes the step of directing a client request by an N-blade to a mirrored root VFS of a virtual server. Preferably, there is the step of sending by the N-blade a lookup RPC to a VLDB 830. There is preferably the step of responding by the VLDB 830 to the lookup RPC with a list of identical but distinct root mirrors or the parent VFS if there are no root mirrors. Preferably, there is the step of satisfying the client request with one of the mirrors on the list on the D-blade.

In the operation of the preferred embodiment, the following terms are applicable.

Virtual File System (VFS): A logical container implementing the Spinnaker File System (SpinFS). A VFS is managed as a single unit; the entire VFS can be mounted, moved, copied or mirrored, but not any subset thereof.

Virtual Server: A Virtual Server is comprised of one root VFS and zero or more sub-root VFSes. A new VFS can be added to or removed from the virtual server at any time by mounting or unmounting it. All the VFSes of a virtual server are collectively referred to as the name space of the virtual server.

Mirror: A mirror is a read-only copy of a VFS. The mirror is identical to the original read-write VFS except that it has a different VFSID. There can be multiple mirrors for a given read-write VFS.

VLDB: The VFS Location Database which keeps track of the locations of all VFS in the Virtual Server. Each VFS record in the VLDB identifies the VFS by name, ID and Storage Pool ID.

A SpinFS mount point is a file system object which is externally visible. It is like a symbolic link in a UNIX file system in that it refers to something else. That is, a client can see a mount point like any other directory or file by listing the contents of a directory containing a mount point. The name of the mount point is arbitrary; it has no meaning to the file system and is given a convenient name by the administrator. Internally, a mount point refers to a VFS by VFS name and a directory inode within the referred to VFS. The inode (Index Node) is the numeric ID of the directory.

For example, there are two VFSes A and B. VFS A has a ‘/user’ directory (root directory). Within the ‘/user’ directory, there is a mount point named ‘john’ also within VFS A. The mount point would have been created in VFS A by mounting VFS B using the SpinServer mgmt software command ‘mount -vfsname B -mounttype context -mountpath /user/john’.

To see the mount point ‘john’, a client would list the contents of ‘/user’ (e.g. ls /user). Internally, the mount point ‘john’ refers to both VFS B by name ‘B’ and the root directory of VFS B by the directory inode. When a client lists the contents ‘/user/john’ the contents of root directory of VFS B are listed. Or, when a client navigates or changes directory to ‘/user/john’ the client lands in ‘/user/john’.

The following example deployment uses mirrors and context mount points to achieve the distribution and access of executable binary files (read-only files).

Assume that multiple sites are needed within an organization. A filer is placed at each site forming a cluster of two with a global file system name space. Without mirrors each site can transparently access the executable files located in the read-write VFS over a Wide Area Network (WAN). This is made possible because of the global name space implementation. But to minimize the WAN delays or failures the executable files will be mirrored to each site. When a new version of an application becomes available or a new application must be deployed, then the executable file for the application must be distributed for use. The distribution is accomplished by mirroring (copying new file blocks) from the read-write VFS containing new executable files to a remote mirror VFS located at each site.

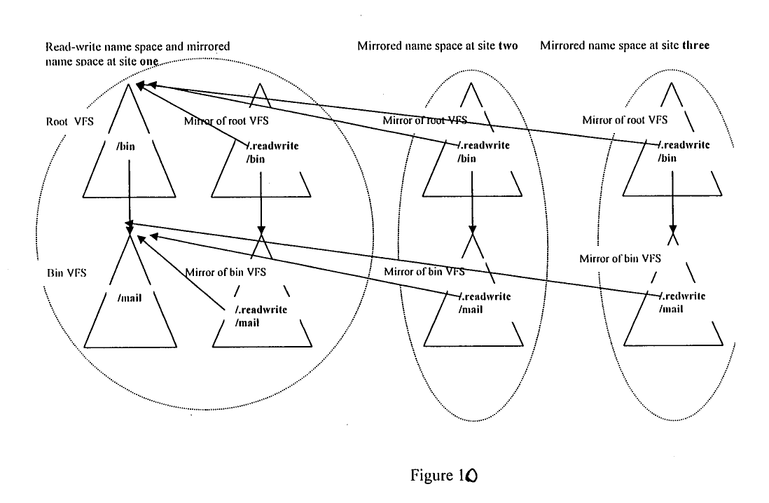

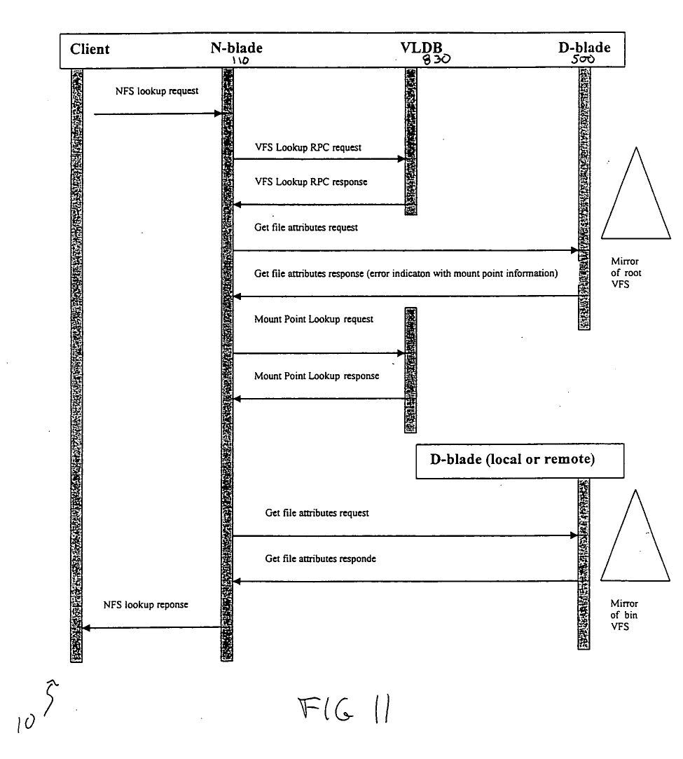

Further assume that ‘/bin’ is a context mount point which refers to a mirror VFS containing the executable files. When ‘/bin/mail’ is accessed by any site the local copy of ‘/bin/mail’ is read. See FIG. 10. This behavior occurs because accessing the root ‘/’ places a client in a mirror of the root VFS, co-located at the client's site. Accessing ‘/bin’ causes the mirror of the “bin” VFS also co-located at the client's site because the client was in the mirrored name space when crossing the ‘/bin’ mount point (i.e. the clients context was a mirror/read-only context when the mount point was interpreted).

VFS mounting occurs in the following preferred way.

A VFS is added to the name space by mounting it inside an existing VFS using a SpinFS mount point. The two VFSes involved in the mount operation form a parent and child relationship. A VFS can be mounted in only one place in the name space; that is, it can have only one parent.

The filer management command ‘filestorage vfs mount’ is used to create a context mount point. The system management component sends a SpinFS RPC call to the D-blade to create the mount point in response to the mount command. This mount point object is similar to a regular file and contains the name of the child VFS.

Mounting a VFS involves initializing internal bi-directional meta-data between the parent and child VFS as well as creating a client visible mount point object in the file system. A SpinFS RPC call is made to create the mount point in the parent. Next, internal meta-data within the child VFS is initialized (with a second RPC call) to refer to the parent VFS. Specifically, it refers to both the directory and mount point within the directory of the parent VFS. The child meta-data is used for traversing up (e.g. ‘cd . .’) the name space from the root of the child VFS to the directory containing the mount point in the parent VFS.

When the administrator mounts a VFS (with a path name) mgmt first verifies the VFS exists by making a VLDB 830 lookup call then verifies the VFS is not already mounted. A SpinFS RPC lookup call is then made to learn the File ID (FID) of the directory that will contain the mount point. The mount string is constructed. The mount string contains the VFS name of the child VFS and is used to initialize the meta-data for the mount point object. Given the directory FID and mount string, the mount point is created using a SpinFS RPC call. Finally the mounted-at attributes (meta-data) are set with the D-blade RPC call.

Context mount points are configured in the read-write name space when there is an intention to mirror that name space. The name space to be mirrored starts from the root of a virtual server and extends downward. FIG. 10 depicts the name space of a virtual server made up of two read-write VFSes at site one and mirrors of these two VFSes at sites one, two and three. The read-write root VFS has a mount point ‘/bin’ configured by the administrator. The mirrors of the read-write root VFS also contain the mount point ‘/bin’. The ‘/bin’ mount point is not created by the administrator since a mirror is read-only VFS. Instead, all files, directories and mount points are created in a mirror by the action of copying of file system, in bulk, from the read-write VFS to its mirror.

A special ‘/.readwrite’ mount point is automatically created by the system management software when each read-write VFS is created. When a read-write VFS is mirrored, its mirror will refer back to the read-write VFS through the ‘/.readwrite’ mount point.

The ‘/.readwrite’ mount point is used by a client to get from a mirror VFS to the mirror's read-write counterpart.

Clients gain access to the mirrored name space through a root VFS. The N-blade directs a client request to the mirrored root VFS of a virtual server. When a root VFS has one or more mirrors, then one of the mirrors is used to satisfy client request. Mirror selection process is carried out by the N-blade. The N-blade sends the Root VFS Lookup RPC to the VLDB 830. The VLDB 830 responds with a list of identical but distinct root mirrors or the read-write VFS if there are no mirrors.

The D-blade closest to the requesting N-blade is chosen based on the “Server Proximity Table”. The “Server Proximity Table” is a mapping of D-blade Ids to Proximities. This mapping allows for a choice of mirrors based on the cost of the request/response roundtrip. If a list of one was returned (Read/Write VFS or a single mirror) obviously it will be selected. If the returned list contained multiple entries, they are sorted based on proximity before being added to the VLDB 830 cache. If during the normal course of operation a request is denied by the D-blade (for cluster reasons) the offending entry is removed from the cache and the next closest D-blade having that mirror is used.

The root VFS type (mirror/RW) sets the starting context for the first mount point crossing.

A client protocol lookup request that has the name of a SpinFs mount point as the file system object is resolved as follows (see FIG. 11):

1. A SpinFs Lookup request is issued to the D-blade in question with the file system object and its directory File Handle. If the file system object is a SpinFs mount point the text content of that SpinFs mount point is returned along with an error code identifying the response as a SpinFs mount point.

2. The N-blade determines the SpinFs mount point type based on the text content of the error message—if the SpinFs mount point is a context mount point and the directory File Handle is a mirror File Handle then the N-blade prefixes the text content of the SpinFs mount point string with the mirror selector. If the SpinFs mount point is not a context mount point or the directory File Handle is not a mirror File Handle the text content of the SpinFs mount point string is not altered.

3. The N-blade sends the SpinFs mount point lookup RPC to the VLDB 830. The VLDB 830 responds with a list of identical but distinct mirrors or the read-write VFS if there are no mirrors.

4. The D-blade closest to the requesting N-blade is chosen based on the “Server Proximity Table”. If a list of one was returned (Read/Write VFS or a single mirror) obviously it will be selected. If the returned list contained multiple entries, they are sorted based on proximity before being added to the VLDB 830 cache.

5. The N-blade then sends the SpinFS get attributes RPC for the SpinFs mount point to the D-blade that has the VFS closest to the requesting N-blade.

6. Finally, the D-blade responds to the SpinFS get attributes call. The N-blade then uses the attributes from the SpinFS call to construct the client lookup response.

If the path is being traversed in the reverse direction (i.e. child to parent) exactly the same procedure is followed except the SpinFs mount point is called a SpinFS mounted at file system object.

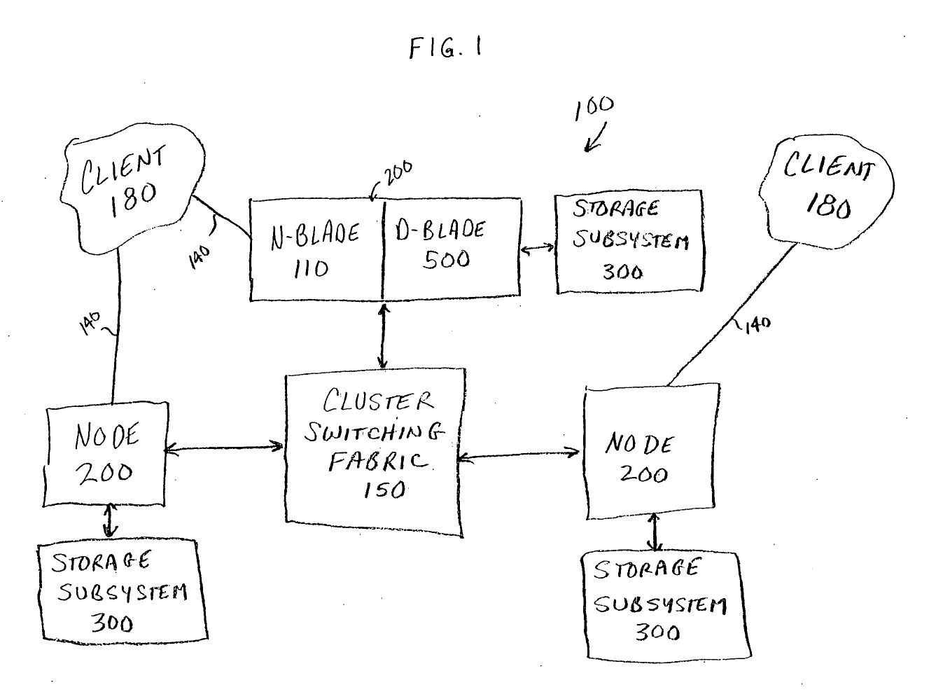

FIG. 1 is a schematic block diagram of a plurality of nodes 200 interconnected as a cluster 100 and configured to provide storage service relating to the organization of information on storage devices of a storage subsystem. The nodes 200 comprise various functional components that cooperate to provide a distributed Spin File System (SpinFS) architecture of the cluster 100. To that end, each SpinFS node 200 is generally organized as a network element (N-blade 110) and a disk element (D-blade 500). The N-blade 110 includes a plurality of ports that couple the node 200 to clients 180 over a computer network 140, while each D-blade 500 includes a plurality of ports that connect the node to a storage subsystem 300. The nodes 200 are interconnected by a cluster switching fabric 150 which, in the illustrative embodiment, may be embodied as a Gigabit Ethernet switch. The distributed SpinFS architecture is generally described in U.S. Patent Application Publication No. US 2002/0116593 titled “Method and System for Responding to File System Requests”, by M. Kazar et al. published Aug. 22, 2002, incorporated by reference herein.

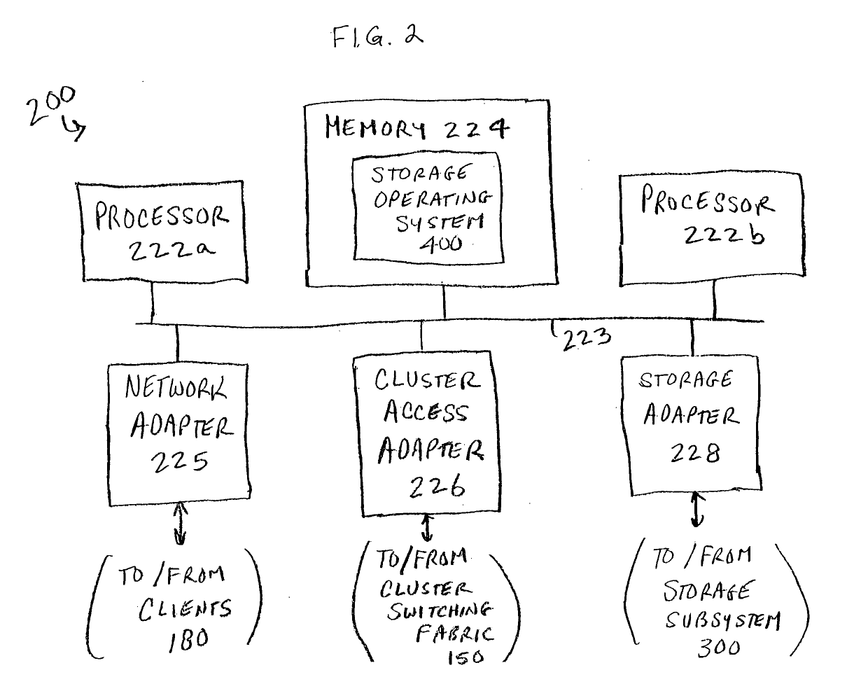

FIG. 2 is a schematic block diagram of a node 200 that is illustratively embodied as a storage system server comprising a plurality of processors 222, a memory 224, a network adapter 225, a cluster access adapter 226 and a storage adapter 228 interconnected by a system bus 223. The cluster access adapter 226 comprises a plurality of ports adapted to couple the node 200 to other nodes of the cluster 100. In the illustrative embodiment, Ethernet is used as the clustering protocol and interconnect media, although it will be apparent to those skilled in the art that other types of protocols and interconnects may be utilized within the cluster architecture described herein.

Each node 200 is illustratively embodied as a dual processor server system executing a storage operating system 300 that provides a file system configured to logically organize the information as a hierarchical structure of named directories and files on storage subsystem 300. However, it will be apparent to those of ordinary skill in the art that the node 200 may alternatively comprise a single or more than two processor system. Illustratively, one processor 222a executes the functions of the N-blade 110 on the node, while the other processor 222b executes the functions of the D-blade 500.

In the illustrative embodiment, the memory 224 comprises storage locations that are addressable by the processors and adapters for storing software program code and data structures associated with the present invention. The processor and adapters may, in turn, comprise processing elements and/or logic circuitry configured to execute the soft-ware code and manipulate the data structures. The storage operating system 300, portions of which are typically resident in memory and executed by the processing elements, functionally organizes the node 200 by, inter alia, invoking storage operations in support of the storage service implemented by the node. It will be apparent to those skilled in the art that other processing and memory means, including various computer readable media, may be used for storing and executing program instructions pertaining to the inventive system and method described herein.

The network adapter 225 comprises a plurality of ports adapted to couple the node 200 to one or more clients 180 over point-to-point links, wide area networks, virtual private networks implemented over a public network (Internet) or a shared local area network, hereinafter referred to as an Ethernet computer network 140. Therefore, the network adapter 225 may comprise a network interface card (NIC) having the mechanical, electrical and signaling circuitry needed to connect the node to the network. For such a network attached storage (NAS) based network environment, the clients are configured to access information stored on the node 200 as files. The clients 180 communicate with each node over network 140 by exchanging discrete frames or packets of data according to pre-defined protocols, such as the Transmission Control Protocol/Internet Protocol (TCP/IP).

The storage adapter 228 cooperates with the storage operating system 400 executing on the node 200 to access information requested by the clients. The information may be stored on disks or other similar media adapted to store information. The storage adapter comprises a plurality of ports having input/output (I/O) interface circuitry that couples to the disks over an I/O interconnect arrangement, such as a conventional high-performance, Fibre Channel (FC) link topology. The information is retrieved by the storage adapter and, if necessary, processed by the processor 222 (or the adapter 228 itself) prior to being forwarded over the system bus 223 to the network adapter 225 where the information is formatted into packets or messages and returned to the clients.

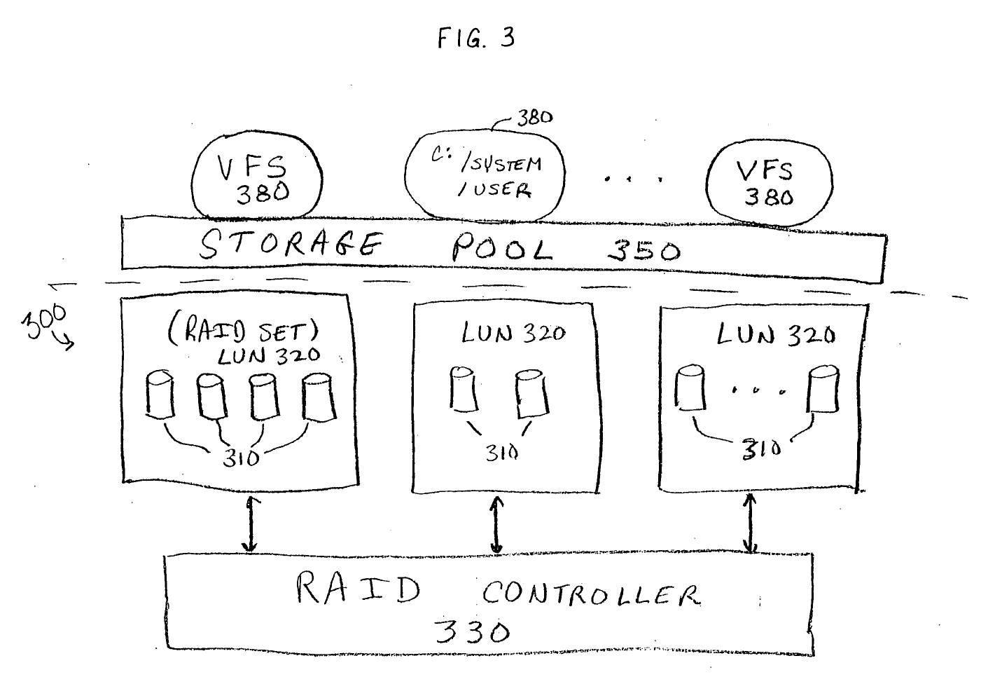

FIG. 3 is a schematic block diagram illustrating the storage subsystem 300 that may be advantageously used with the present invention. Storage of information on the storage subsystem 300 is illustratively implemented as a plurality of storage disks 310 defining an overall logical arrangement of disk space. The disks are further organized as one or more groups or sets of Redundant Array of Independent (or Inexpensive) Disks (RAID). RAID implementations enhance the reliability/integrity of data storage through the writing of data “stripes” across a given number of physical disks in the RAID group, and the appropriate storing of redundant information with respect to the striped data. The redundant information enables recovery of data lost when a storage device fails. It will be apparent to those skilled in the art that other redundancy techniques, such as mirroring, may used in accordance with the present invention.

Each RAID set is configured by one or more RAID controllers 330. The RAID controller 330 exports a RAID set as a logical unit number (LUN 320) to the D-blade 500, which writes and reads blocks to and from the LUN 320. One or more LUNs are illustratively organized as a storage pool 350, wherein each storage pool 350 is “owned” by a D-blade 500 in the cluster 100. Ownership here, means the D-blade 500 responsible for servicing the request. Each storage pool 350 is further organized as a plurality of virtual file systems (VFSs 380), each of which is also owned by the D-blade. Each VFS 380 may be organized within the storage pool according to a hierarchical policy that, among other things, allows the VFS to be dynamically moved among nodes of the cluster, thereby enabling the storage pool 350 to grow (on the fly).

In the illustrative embodiment, a VFS 380 is synonymous with a volume and comprises a root directory, as well as a number of subdirectories and files. A group of VFSs may be composed into a larger namespace. For example, a root directory (c:) may be contained within a root VFS (“/”), which is the VFS that begins a translation process from a pathname associated with an incoming request to actual data (file) in a file system, such as the SpinFS file system. The root VFS may contain a directory (“system”) or a mount point (“user”). A mount point is a SpinFS object used to “vector off” to another VFS and which contains the name of that vectored VFS. The file system may comprise one or more VFSs that are “stitched together” by mount point objects.

To facilitate access to the disks 310 and information stored thereon, the storage operating system 400 implements a write-anywhere file system, such as the SpinFS file system, which logically organizes the information as a hierarchical structure of named directories and files on the disks. However, it is expressly contemplated that any appropriate storage operating system, including a write in-place file system, may be enhanced for use in accordance with the inventive principles described herein. Each “on-disk” file may be implemented as set of disk blocks configured to store information, such as data, whereas the directory may be implemented as a specially formatted file in which names and links to other files and directories are stored.

As used herein, the term “storage operating system” generally refers to the computer-executable code operable on a computer that manages data access and may, in the case of a node 200, implement data access semantics of a general purpose operating system. The storage operating system can also be implemented as a microkernel, an application program operating over a general-purpose operating system, such as UNIX® or Windows NT®, or as a general-purpose operating system with configurable functionality, which is configured for storage applications as described herein.

In addition, it will be understood to those skilled in the art that the inventive system and method described herein may apply to any type of special-purpose (e.g., storage serving appliance) or general-purpose computer, including a standalone computer or portion thereof, embodied as or including a storage system. Moreover, the teachings of this invention can be adapted to a variety of storage system architectures including, but not limited to, a network-attached storage environment, a storage area network and disk assembly directly-attached to a client or host computer. The term “storage system” should therefore be taken broadly to include such arrangements in addition to any subsystems configured to perform a storage function and associated with other equipment or systems.

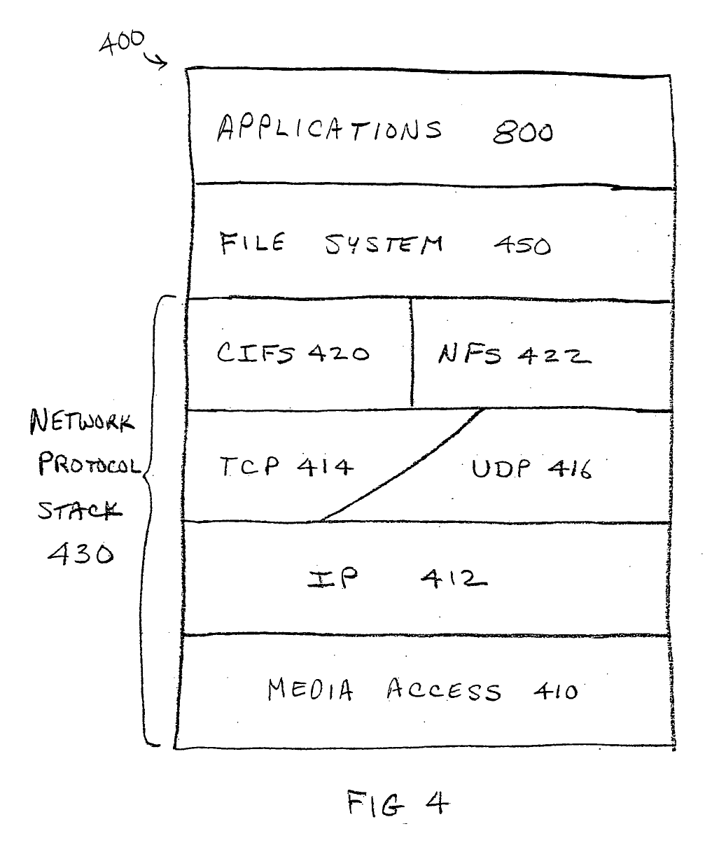

FIG. 4 is a schematic block diagram of the storage operating system 400 that may be advantageously used with the present invention. The storage operating system comprises a series of software layers organized to form an integrated network protocol stack 430 that provides a data path for clients to access information stored on the node 200 using file access protocols. The protocol stack includes a media access layer 410 of network drivers (e.g., gigabit Ethernet drivers) that interfaces to network protocol layers, such as the IP layer 412 and its supporting transport mechanisms, the TCP layer 414 and the User Datagram Protocol (UDP) layer 416. A file system protocol layer provides multi-protocol file access to a file system 450 (the SpinFS file system) and, thus, includes support for the CIFS protocol 220 and the NFS protocol 222. As described further herein, a plurality of management processes executes as user mode applications 800.

In the illustrative embodiment, the processors 222 share various resources of the node 200, including the storage operating system 400. To that end, the N-blade 110 executes the integrated network protocol stack 430 of the operating system 400 to thereby perform protocol termination with respect to a client issuing incoming NFS/CIFS file access request packets over the network 150. The NFS/CIFS layers of the network protocol stack function as NFS/CIFS servers 422, 420 that translate NFS/CIFS requests from a client into SpinFS protocol requests used for communication with the D-blade 500. The SpinFS protocol is a file system protocol that provides operations related to those operations contained within the incoming file access packets. Local communication between an N-blade and D-blade of a node is preferably effected through the use of message passing between the blades, while remote communication between an N-blade and D-blade of different nodes occurs over the cluster switching fabric 150.

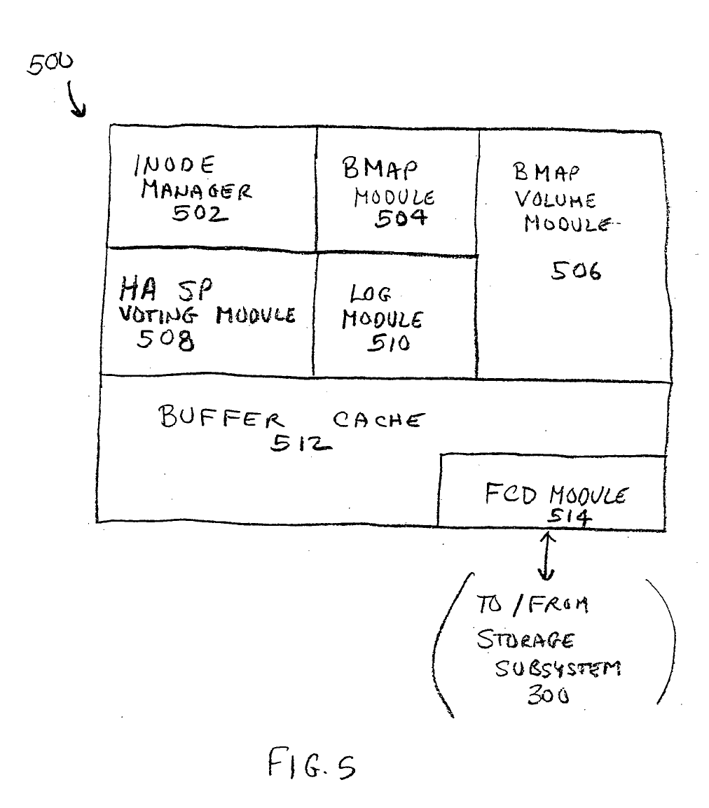

Specifically, the NFS and CIFS servers of an N-blade 110 convert the incoming file access requests into SpinFS requests that are processed by the D-blades 500 of the cluster 100. Each D-blade 500 provides a disk interface function through execution of the SpinFS file system 450. In the illustrative cluster 100, the file systems 450 cooperate to provide a single SpinFS file system image across all of the D-blades in the cluster. Thus, any network port of an N-blade that receives a client request can access any file within the single file system image located on any D-blade 500 of the cluster. FIG. 5 is a schematic block diagram of the D-blade 500 comprising a plurality of functional components including a file system processing module (the inode manager 502), a logical-oriented block processing module (the Bmap module 504) and a Bmap volume module 506. Note that inode manager 502 is the processing module that implements the SpinFS file system 450. The D-blade also includes a high availability storage pool (HA SP) voting module 508, a log module 510, a buffer cache 512 and a fiber channel device driver (FCD).

The Bmap module 504 is responsible for all block allocation functions associated with a write anywhere policy of the file system 450, including reading and writing all data to and from the RAID controller 330 of storage subsystem 300. The Bmap volume module 506, on the other hand, implements all VFS operations in the cluster 100, including creating and deleting a VFS, mounting and unmounting a VFS in the cluster, moving a VFS, as well as cloning (snapshotting) and mirroring a VFS. Note that mirrors and clones are read-only storage entities. Note also that the Bmap and Bmap volume modules do not have knowledge of the underlying geometry of the RAID controller 330, only free block lists that may be exported by that controller.

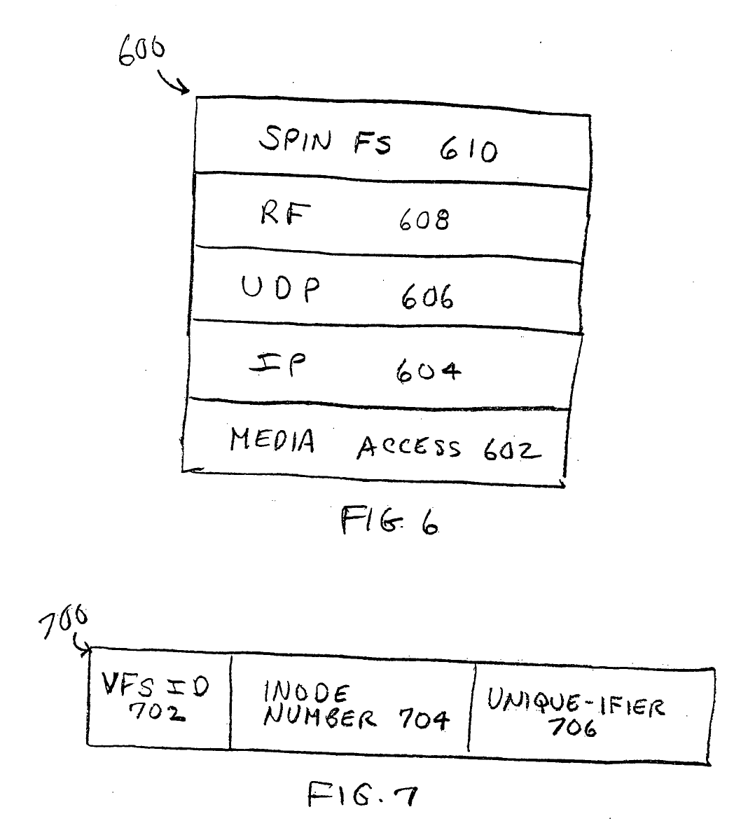

The NFS and CIFS servers on the N-blade 110 translate respective NFS and CIFS requests into SpinFS primitive operations contained within SpinFS packets (requests). FIG. 6 is a schematic block diagram illustrating the format of a SpinFS request 600 that illustratively includes a media access layer 602, an IP layer 604, a UDP layer 606, an RF layer 608 and a SpinFS protocol layer 610. As noted, the SpinFS protocol 610 is a file system protocol that provides operations, related to those operations contained within incoming file access packets, to access files stored on the cluster 100. Illustratively, the SpinFS protocol 610 is datagram based and, as such, involves transmission of packets or “envelopes” in a reliable manner from a source (e.g., an N-blade) to a destination (e.g., a D-blade). The RF layer 608 implements a reliable transport protocol that is adapted to process such envelopes in accordance with a connectionless protocol, such as UDP 606.

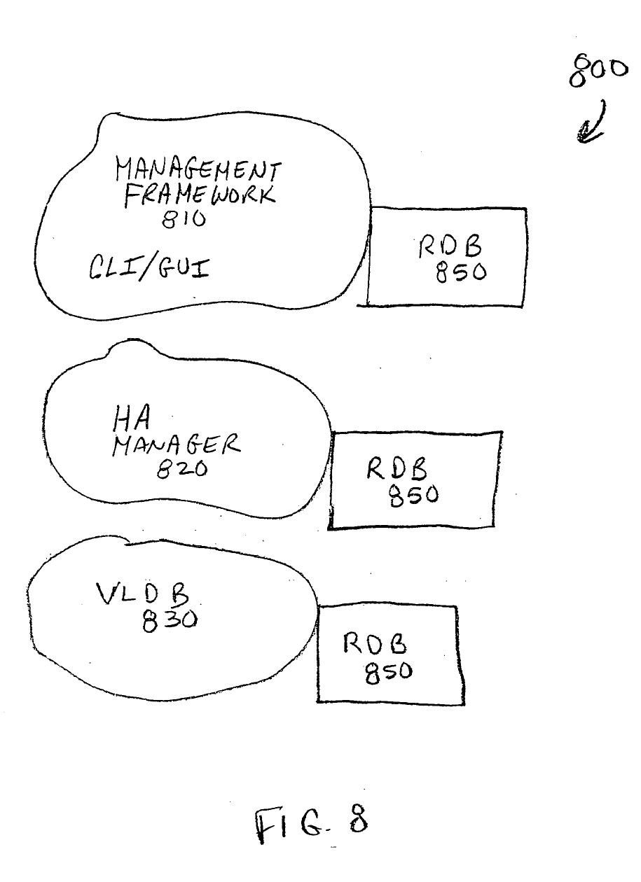

Files are accessed in the SpinFS file system 450 using a file handle. FIG. 7 is a schematic block diagram illustrating the format of a file handle 700 including a VFS ID field 702, an inode number field 704 and a unique-ifier field 706. The VFS ID field 702 contains an identifier of a VFS that is unique (global) within the entire cluster 100. The inode number field 704 contains an inode number of a particular inode within an inode file of a particular VFS. The unique-ifier field 706 contains a monotonically increasing number that uniquely identifies the file handle 700, particularly in the case where an inode number has been deleted, reused and reassigned to a new file. The unique-ifier distinguishes that reused inode number in a particular VFS from a potentially previous use of those fields.

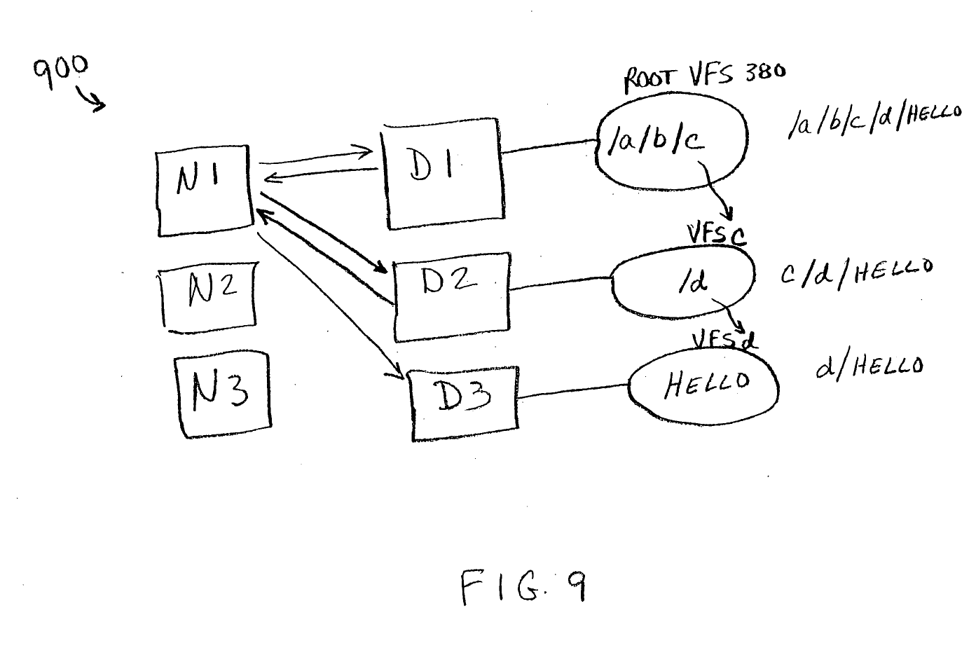

FIG. 8 is a schematic block diagram illustrating a collection of management processes that execute as user mode applications 800 on the storage operating system 400. The management processes include a management framework process 810, a high availability manager (HA Mgr) process 820, a VFS location database 830 (VLDB) process 830 and a replicated database (RDB) process 850. The management framework 810 provides a user interface via a command line interface (CLI) and/or graphical user interface (GUI). The management framework is illustratively based on a conventional common interface model (CIM) object manager that provides the entity to which users/system administrators interact with a node 200 in order to manage the cluster 100.

The HA Mgr 820 manages all network addresses (IP addresses) of all nodes 200 on a cluster-wide basis. For example, assume a network adapter 225 having two IP addresses (IP1 and IP2) on a node fails. The HA Mgr 820 relocates those two IP addresses onto another N-blade of a node within the cluster to thereby enable clients to transparently survive the failure of an adapter (interface) on an N-blade 110. The relocation (re-positioning) of IP addresses within the cluster is dependent upon configuration information provided by a system administrator. The HA Mgr 820 is also responsible for functions such as monitoring an uninterrupted power supply (UPS) and notifying the D-blade to write its data to persistent storage when a power supply issue arises within the cluster.

The VLDB 830 is a database process that tracks the locations of various storage components (e.g., a VFS) within the cluster 100 to thereby facilitate routing of requests throughout the cluster. In the illustrative embodiment, the N-blade 110 of each node has a look up table that maps the VS ID 702 of a file handle 700 to a D-blade 500 that “owns” (is running) the VFS 380 within the cluster. The VLDB 830 provides the contents of the look up table by, among other things, keeping track of the locations of the VFSs 380 within the cluster. The VLDB 830 has a remote procedure call (RPC) interface, e.g., a Sun RPC interface, which allows the N-blade 110 to query the VLDB 830. When encountering a VFS ID 702 that is not stored in its mapping table, the N-blade sends an RPC to the VLDB 830 process. In response, the VLDB 830 returns to the N-blade the appropriate mapping information, including an identifier of the D-blade that owns the VFS. The N-blade caches the information in its look up table and uses the D-blade ID to forward the incoming request to the appropriate VFS 380.

All of these management processes have interfaces to (are closely coupled to) the RDB 850. The RDB comprises a library that provides a persistent object store (storing of objects) pertaining to configuration information and status throughout the cluster. Notably, the RDB 850 is a shared database that is identical (has an identical image) on all nodes 200 of the cluster 100. For example, the HA Mgr 820 uses the RDB library 850 to monitor the status of the IP addresses within the cluster. At system startup, each node 200 records the status/state of its interfaces and IP addresses (those IP addresses it “owns”) into the RDB database.

Operationally, requests are issued by clients 180 and received at the network protocol stack 430 of an N-blade 110 within a node 200 of the cluster 100. The request is parsed through the network protocol stack to the appropriate NFS/CIFS server, where the specified VFS 380 (and file), along with the appropriate D-blade 500 that “owns” that VFS, are determined. The appropriate server then translates the incoming request into a SpinFS request 600 that is routed to the D-blade 500. The D-blade receives the SpinFS request and apportions it into a part that is relevant to the requested file (for use by the inode manager 502), as well as a part that is relevant to specific access (read/write) allocation with respect to blocks on the disk (for use by the Bmap module 504). All functions and interactions between the N-blade 110 and D-blade 500 are coordinated on a cluster-wide basis through the collection of management processes and the RDB library user mode applications 800.

FIG. 9 is a schematic block diagram illustrating a distributed file system (SpinFS) arrangement 900 for processing a file access request at nodes 200 of the cluster 100. Assume a CIFS request packet specifying an operation directed to a file having a specified pathname is received at an N-blade 110 of a node 200. Specifically, the CIFS operation attempts to open a file having a pathname /a/b/c/d/Hello. The CIFS server 420 on the N-blade 110 performs a series of lookup calls on the various components of the pathname. Broadly stated, every cluster 100 has a root VFS 380 represented by the first “/” in the pathname. The N-blade 110 performs a lookup operation into the lookup table to determine the D-blade “owner” of the root VFS and, if that information is not present in the lookup table, forwards a RPC request to the VLDB 830 in order to obtain that location information. Upon identifying the D1 D-blade owner of the root VFS, the N-blade 110 forwards the request to D1, which then parses the various components of the pathname.

Assume that only a/b/ (e.g., directories) of the pathname are present within the root VFS. According to the SpinFS protocol, the D-blade 500 parses the pathname up to a/b/, and then returns (to the N-blade) the D-blade ID (e.g., D2) of the subsequent (next) D-blade that owns the next portion (e.g., c/) of the pathname. Assume that D3 is the D-blade that owns the subsequent portion of the pathname (d/Hello). Assume further that c and d are mount point objects used to vector off to the VFS that owns file Hello. Thus, the root VFS has directories a/b/ and mount point c that points to VFS c which has (in its top level) mount point d that points to VFS d that contains file Hello. Note that each mount point may signal the need to consult the VLDB 830 to determine which D-blade owns the VFS and, thus, to which D-blade the request should be routed.

The N-blade (N1) that receives the request initially forwards it to D-blade D1, which send a response back to N1 indicating how much of the pathname it was able to parse. In addition, D1 sends the ID of D-blade D2 which can parse the next portion of the pathname. N-blade N1 then sends to D-blade D2 the pathname c/d/Hello and D2 re-turns to N1 an indication that it can parse up to c/, along with the D-blade ID of D3 which can parse the remaining part of the pathname. N1 then sends the remaining portion of the pathname to D3 which then accesses the file Hello in VFS d. Note that the distributed file system arrangement 900 is performed in various parts of the cluster architecture including the N-blade 110, the D-blade 500, the VLDB 830 and the management framework 810.

The distributed SpinFS architecture includes two separate and independent voting mechanisms. The first voting mechanism involves storage pools 350 which are typically owned by one D-blade 500 but may be owned by more than one D-blade, although not all at the same time. For this latter case, there is the notion of an active or current owner of the storage pool, along with a plurality of standby or secondary owners of the storage pool. In addition, there may be passive secondary owners that are not “hot” standby owners, but rather “cold” standby owners of the storage pool. These various categories of owners are provided for purposes of failover situations to enable high availability of the cluster and its storage resources. This aspect of voting is performed by the HA SP voting module 508 within the D-blade 500. Only one D-blade can be the primary active owner of a storage pool at a time, wherein ownership denotes the ability to write data to the storage pool. In essence, this voting mechanism provides a locking aspect/protocol for a shared storage resource in the cluster. This mechanism is further described in U.S. Patent Application Publication No. US 2003/0041287 titled “Method and System for Safely Arbitrating Disk Drive Ownership”, by M. Kazar published Feb. 27, 2003, incorporated by reference herein.

The foregoing description has been directed to particular embodiments of this invention. It will be apparent, however, that other variations and modifications may be made to the described embodiments, with the attainment of some or all of their advantages. Specifically, it should be noted that the principles of the present invention may be implemented in/with non-distributed file systems. Furthermore, while this description has been written in terms of N- and D-blades, the teachings of the present invention are equally suitable to systems where the functionality of the N- and D-blades are implemented in a single system. Alternately, the functions of the N- and D-blades may be distributed among any number of separate systems wherein each system performs one or more of the functions. Additionally, the procedures or processes may be implemented in hardware, software, embodied as a computer-readable medium having program instructions, firmware, or a combination thereof. Therefore, it is the object of the appended claims to cover all such variations and modifications as come within the true spirit and scope of the invention.

1. A method for keeping a file system client in a read-only name space of the file system comprising the steps of:
creating a context mount point in an existing VFS in the read-only name space; and
adding a new VFS to the name space at the mount point to the existing VFS.

2. A method as described in claim 1 including the step of receiving a mount command for the new VFS at a system network component.

3. A method as described in claim 2 including the step of sending a create call to a disk element to create the mount point.

4. A method as described in claim 3 wherein the adding step includes the step of forming a parent and child relationship between the existing VFS and the new VFS, respectively.

5. A method as described in claim 4 wherein the creating step includes the step of creating the mount point having a name of the child VFS.

6. A method as described in claim 5 including the step of initializing internal bi-directional meta-data between the parent VFS and the child VFS.

7. A method as described in claim 6 including the step of creating a client visible mount point object in the file system.

8. A method as described in claim 7 including the step of initializing internal meta-data within the child VFS to refer to the parent VFS.

9. A method as described in claim 8 wherein the initializing internal meta-data within the child of the VFS step includes the step of referring the internal meta-data with the child VFS to both a directory and the mount point within the directory of the parent VFS.

10. A method as described in claim 9 including the step of verifying the parent VFS exists.

11. A method as described in claim 10 including the step of verifying the parent VFS is not already mounted.

12. A method as described in claim 11 including the step of learning a file ID of the directory having the mount point.

13. A method as described in claim 12 including the step of constructing a mount string having a name of the VFS child.

14. A method as described in claim 13 wherein the parent VFS has a read-write name space and including the step of mirroring the name space of the parent VFS in a read only name-space of the child VFS.

15. A method as described in claim 14 including the step of gaining access by the client to the mirrored name space of the child VFS through a root VFS.

16. A method as described in claim 15 wherein the gaining access step includes the step of directing a client request by an N-blade to a mirrored root VFS of a virtual server.

17. A method as described in claim 16 including the step of sending by the N-blade a lookup RPC to a VLDB.

18. A method as described in claim 17 including the step of responding by the VLDB to the lookup RPC with a list of identical but distinct root mirrors or the parent VFS if there are no root mirrors.

19. A method as described in claim 18 wherein the disk element includes a D-blade and including the step of satisfying the client request with one of the mirrors on the list on the D-blade.

20. An apparatus for keeping a file system client in a read-only name space of the file system comprising:
a system management component which sends create calls in response to mount commands; and
at least a first disk element in communication with the system management component which receives the create calls and creates mount points in the read only name space in response to the mound commands.

21. An apparatus as described in claim 20 wherein the disk element has a plurality of existing parent VFS, and the disk element creates the mount points in the parent VFS and mounts a child VFS at a mount point in the parent VFS.

22. An apparatus as described in claim 21 wherein the disk element includes a D-blade.

23. An apparatus as described in claim 22 including a VFS location database which maintains locations of all VFS in communication with the D-blade.

24. An apparatus as described in claim 23 wherein the system management component includes a network element in communication with the D-blade and the database which receives look-up requests from clients.

25. An apparatus as described in claim 24 wherein the network element is an N-blade.
